(19) United States
(12) Patent Application Publication
(10) Pub. No.: US 2017/0292562 A1
(43) Pub. Date: Oct. 12, 2017

(54) FLEXURE JOINT APPARATUS

(71) Applicants: Sug Whan KIM, Gimpo-si (KR); SPHEREDYNE CO., LTD., Seoul (KR)

(72) Inventor: Sug Whan KIM, Gimpo-si (KR)

(21) Appl. No.: 15/632,777

(22) Filed: Jun. 26, 2017

Related U.S. Application Data
(63) Continuation of application No. PCT/KR2015/014168, filed on Dec. 23, 2015.

(30) Foreign Application Priority Data
Dec. 26, 2014 (KR) 10-2014-0191116
Apr. 16, 2015 (KR) 10-2015-0053766
Apr. 16, 2015 (KR) 10-2015-0053767

(51) Int. Cl. F16C 11/06; F16D 3/221

(52) U.S. Cl. CPC F16C 11/06; F16D 3/221; F16D 3/22

(57) ABSTRACT

A flexure joint apparatus includes a first fixing unit, at least one first flexure extending from the first fixing unit, and a connection member having a first head elastically supported by the at least one first flexure.

### CROSS-REFERENCE TO RELATED APPLICATIONS

The present application is a continuation application of PCT international patent application No. PCT/KR2015/014168 filed on Dec. 23, 2015, which claims the priority to Korean patent application Nos. 10-2014-0191116 filed on Dec. 26, 2014, 10-2015-0053766 filed on Apr. 16, 2015, and 10-2015-0053767 filed on Apr. 16, 2015, the contents of which are hereby incorporated by reference in their entirety.

### TECHNICAL FIELD

The present inventive concept relates to a flexure joint apparatus.

### BACKGROUND ART

Joint apparatuses have been widely applied to animals, human bodies, mechanical apparatuses, or various industrial goods.

In general, the functions of a joint may include 1) transferring a force from one side to another side; 2) changing a direction of the transferred force, when necessary; 3) moving in a space between one side and another side, that is, a motion in a certain direction and positional restoration among three-directional linear motions and three-directional rotational motions ; 4) forming a structure by one side and another side in a combined state; 5) existing in one structure when no external force is applied, and separated when an external force over a certain strength is applied; 6) when separated, being recombined to exert the original function, etc.

Although a joint apparatus has the above-described functions of a joint, conventional general joint apparatuses as disclosed in Korean Patent No. 10-1132806 and Korean Patent Publication No. 10-2012-0020727 have a limited number of the functions.

### DETAILED DESCRIPTION OF THE INVENTIVE CONCEPT

### Technical Problem

The present inventive concept provides a flexure joint apparatus, which may be capable of moving with six degrees of freedom, may be separated when an appropriate external force is applied, and may be easily installed without using a special tool.

Furthermore, the present inventive concept provides a flexure joint apparatus, which may react in proportional to the amount of an applied external force and may be restored when the external force is removed.

### Technical Solution

According to an aspect of the present inventive concept, there is provided a flexure joint apparatus, which includes a first fixing unit, at least one first flexure extending from the first fixing unit, and a connection member having a first head elastically supported by the at least one first flexure, in which the first head comprises a first-1 portion having a first-1 thickness and a first-2 portion having a first-2 thickness that is different from the first-1 thickness.

The first flexure may surround at least part of the first head.

The first flexure may include at least one recess portion, and the recess portion may support the first head.

One end of the first flexure may be coupled to the first fixing unit and the other end of the first flexure may be spaced apart from the first fixing unit.

The first flexure may be provided such that opposite ends of the first flexure are coupled to the first fixing unit.

The first head may be provided asymmetrically with respect to an axial direction of the connection member.

The first flexure may further include a twisted portion that is twisted in an extension direction.

The first flexure may further include at least one slit.

The flexure joint apparatus may further include an adhesive between the first flexure and the first head.

The adhesive may have elasticity.

According to an aspect of the present inventive concept, there is provided a flexure joint apparatus, which includes a first fixing unit, at least one first flexure extending from the first fixing unit, and a connection member having a first head elastically supported by the at least one first flexure, in which the first head is provided asymmetrically with respect to an axial direction of the connection member, the first flexure surrounds at least part of the first head, and the first head comprises a first-1 portion having a first-1 thickness and a first-2 portion having a first-2 thickness that is different from the first-1 thickness.

The first flexure may include at least one recess portion, and the recess portion may support the first head.

One end of the first flexure may be coupled to the first fixing unit and the other end of the first flexure may be spaced apart from the first fixing unit.

The first flexure may be provided such that opposite ends of the first flexure are coupled to the first fixing unit.

The first head may be provided asymmetrically with respect to an axial direction of the connection member.

The first flexure may further include a twisted portion that is twisted in an extension direction.

The first flexure may further include at least one slit.

The flexure joint apparatus may further include an adhesive between the first flexure and the first head.

The adhesive may have elasticity.

According to an aspect of the present inventive concept, there is provided a flexure joint apparatus, which includes a first fixing unit, at least one first flexure extending from the first fixing unit, and a connection member having a first head elastically supported by the at least one first flexure, in which the first flexure surrounds at least part of the first head and comprises at least one recess portion that is recessed close to the first fixing unit to support the first head, the first flexure comprises a first protruding portion and a second protruding portion that protrude in a direction away from the first fixing unit and are spaced apart from each other, the recess portion is located between the first protruding portion and the second protruding portion, and the first protruding portion and the second protruding portion are spaced apart from each other from opposite ends of the first flexure.

The first head may include a first-1 portion having a first-1 thickness and a first-2 portion having a first-2 thickness that is different from the first-1 thickness.

One end of the first flexure may be coupled to the first fixing unit and the other end of the first flexure may be spaced apart from the first fixing unit.

The first flexure may be provided such that opposite ends of the first flexure are coupled to the first fixing unit.

The first head may be provided asymmetrically with respect to an axial direction of the connection member.

The first flexure may further include a twisted portion that is twisted in an extension direction.

The first flexure may further include at least one slit.

The flexure joint apparatus may further include an adhesive between the first flexure and the first head.

The adhesive may have elasticity.

### Advantageous Effects

According to the embodiments of the present inventive concept, since the head is capable of performing a linear motion in each of X-axis, Y-axis, and Z-axis directions and a rotational motion with respect to each axis in proportion to an externally applied force, the head has the six degrees of freedom and may perform linear and rotational motions in all direction in a space.

Furthermore, since the flexure joint apparatus according to the present inventive concept is used for various exercise machine and apparatuses, martial arts and exercise training effects may be much enhanced.

Furthermore, since the head can be easily detached from and inserted in the flexure, the head may be repeatedly used.

Furthermore, since the flexure joint apparatus according to the present inventive concept is simple and capable of performing various joint functions of a human body, the flexure joint apparatus may be used in the fields of industrial robots or medial joint mechanism such as rehabilitation.

Furthermore, the flexure joint apparatus according to the present inventive concept may be used for all types of industrial products requiring a flexible support structure.

### DESCRIPTION OF THE DRAWINGS

FIG. 1 illustrates a configuration of a flexure joint apparatus according to an embodiment.

FIG. 2 illustrates a configuration of a flexure joint apparatus according to another embodiment.

FIG. 3 illustrates a configuration of a flexure joint apparatus according to another embodiment.

FIG. 4 illustrates a configuration of a flexure joint apparatus according to another embodiment.

FIGS. 5 and 6 illustrate a configuration of a flexure joint apparatus according to another embodiment.

FIG. 7 illustrates a configuration of a flexure joint apparatus according to another embodiment.

FIGS. 8A to 8D illustrate various modified examples of a first head according to the embodiment illustrated in FIG. 7.

FIG. 9 illustrates a first flexure according to another embodiment.

FIG. 10 illustrates a first flexure according to another embodiment.

FIG. 11 illustrates another example of the flexure joint apparatus of FIG. 1, in detail, an example of a portion A of FIG. 1.

FIGS. 12A to 12C illustrate configurations of a flexure joint apparatus according to another embodiment.

FIG. 13 illustrates a flexure joint apparatus according to another embodiment.

FIG. 14 illustrates a part of a flexure joint apparatus according to another embodiment.

FIGS. 15A to 15C illustrate a part of a flexure joint apparatus according to another embodiment.

### BEST MODE

Hereinafter, embodiments of the present inventive concept are described in detail with respect to the accompanying drawings.

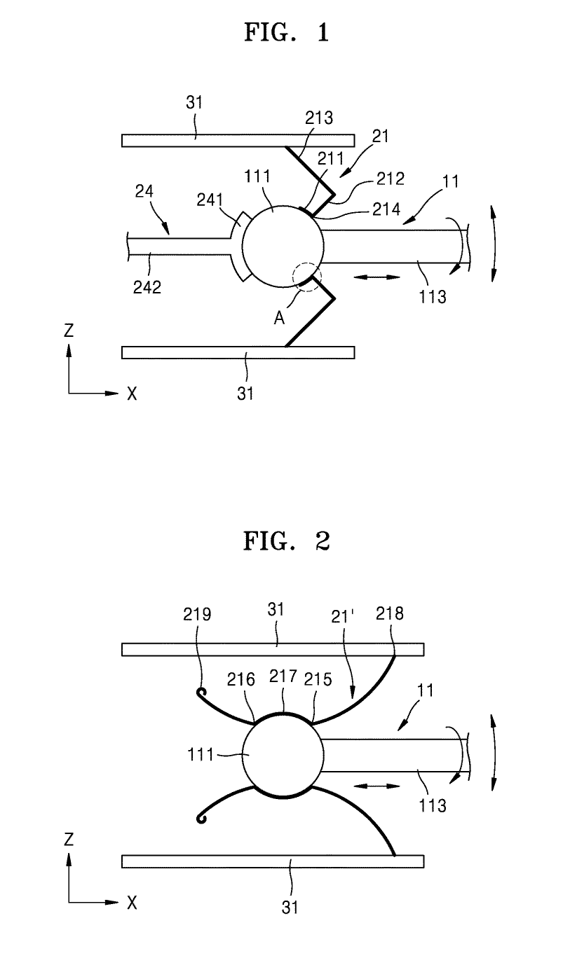

FIG. 1 illustrates a configuration of a flexure joint apparatus according to an embodiment.

Referring to FIG. 1, a joint apparatus according to the present embodiment may include a first fixing unit 31, a connection member 11, and a first flexure 21.

The first fixing unit 31, as shown in FIG. 1, may be a fixing support body including the connection member 11 and the first flexure 21 located inside, and may use a plurality of plate-shaped members facing one another or may be a barrel-shaped member having at least one hollow in an X-axis direction. However, the present disclosure is not limited thereto, and any member may be used only if the first flexure 21 is extendable.

The connection member 11 may include a first head 111 and a rod 113 that are coupled to each other. According to an embodiment, the first head 111 may be formed in a ball shape, whereas the present disclosure is not limited thereto and the first head 111 may be formed in a polyhedral shape, an oval shape, a semicircular shape, a semi-elliptical shape, etc. and selectively in various shapes. In the flexure joint apparatus according to the present embodiment, since it suffices that the first head 111 is elastically supported by the first flexure 21, the shape of the first head 111 is not limited to a specific shape. The rod 113 may extend from one end of the first head 111 in the X-axis direction, but the present disclosure is not limited thereto. At least one rod 113 may extend from the first head 111 in different directions. According to an embodiment, the rod 113 may be a rod having a circular section. However, the present disclosure is not limited thereto, and the rod 113 may be a rod having an oval or polygonal section. In the flexure joint apparatus according to the present embodiment, the rod 113 may extend from the first head 111 to connect the first head 111 to other apparatus and/or organ, and the shape of the rod 113 is not limited to of a specific shape. The first head 111 and the rod 113 may be integrally formed, but the present disclosure is not limited thereto and the first head 111 and the rod 113 may be combined to each other. The rod 113 may be coupled to the first head 111 toward a center of the first head 111. While the rod 113 may be fixed coupled to the first head 111, the rod 113 may be selectively coupled to the first head 111 capable of pivoting around the first head 111.

The first flexure 21 may extend from the first fixing unit 31 to elastically support one side of the first head 111. The first flexure 21 may be a plate-shaped member and may be elastic. The first flexure 21, which is provided in plurality, may extend from the first fixing unit 31 and support the first head 111 at a plurality of positions. However, the present disclosure is not limited thereto, and only one first flexure 21 may be provided to elastically support the first head 111. In the present specification, the term “flexure” may signify a member that is curved to have a certain degree of a restoration force.

The first flexure 21 may be formed as a plate-shaped member that is bent or curved once or plural times. For example, as shown in FIG. 1, the first flexure 21 may be a plate-shaped member that is bent three times in one direction. However, the present disclosure is not limited thereto, and the first flexure 21 may be bent in a multiple times, for example, four times or five times. Accordingly, three or four plate-shaped members may radially surround the first head 111.

The first flexure 21 may include a first extension portion 211, a second extension portion 212, a third extension portion 213, and a first penetration portion 214.

The first extension portion 211 may support the first head 111 and may be formed to correspond to a surface shape of the first head 111. Accordingly, the first extension portion 211 may extend in an inclined direction along the X-axis and/or a Z-axis.

The second extension portion 212 may extend from the first extension portion 211. In the embodiment illustrated in FIG. 1, the second extension portion 212 may extend in an inclined direction opposite to the first extension portion 211 with respect to the Z-axis direction.

The first penetration portion 214 may be located between the first extension portion 211 and the second extension portion 212. The first penetration portion 214 may have an opening shape having a size smaller than the size of the first head 111 at least along the Z-axis direction. Accordingly, the rod 13 may pass through the first penetration portion 214. The first penetration portion 214 may perform a function of a stopper with respect to the motion of the first head 111 in the X-axis direction. Furthermore, the rod 113 may freely pivot in a fan shape in the Z-axis direction around the first head 111. The connection member 11 may be rotated around the X-axis by being supported by the first flexure 21.

The third extension portion 213 may couple the first flexure 21 to the first fixing unit 31. The third extension portion 213 may extend in an inclined direction opposite to the second extension portion 212 with respect to the Z-axis direction.

The first flexure 21 may be integrally formed in the first fixing unit 31 or may be coupled by screws or by welding.

The other side of the first head 111 may be supported by a support 24. The support 24 may include an accommodation portion 241 supporting the other side of the first head 111 and an arm 242 extending from the accommodation portion 241 in the X-axis direction. However, the present disclosure is not limited thereto, and one or more arms may be provided as the arm 242, if necessary, extending from the first head 111 in different directions. At least a surface of the accommodation portion 241 facing the first head 111 may be formed to have a shape corresponding to the shape of the first head 111 to support the other side of the first head 111.

As the support 24 supports the other side of the first head 111, the first flexure 21 supports the first head 111 from the right to the left in the X-axis direction of FIG. 1. As the support 24 supports the first head 111 from the left to the right in the X-axis direction, the first head 111 may be balanced in terms of a force, a position, and/or a posture in the X-axis direction by the support of the first flexure 21 and the support 24.

The support 24 may be provided to be elastic. Accordingly, the first head 111 of flexure joint apparatus may perform a horizontal motion in the X-axis direction. Accordingly, for example, even when a force is applied to the first head 111 from the right to the left in the X-axis direction, the force may be reduced by the support 24.

Since the connection member 11 can rotate and pivot when the connection member 11 is supported by the first flexure 21 and the support 24, a smooth joint structure may be formed.

Although in the embodiment illustrated in FIG. 1 the support 24 supports the other side of the first head 111, the present disclosure is not limited thereto and, instead of the support 24, a separate member or elastic member (not shown) may apply a force to the connection member 11 to achieve balance of a force with the first flexure 21.

The connection member 11 may be inserted in the first penetration portion 214 from the outside to the inside of the first flexure 21, that is, from the right to the left in FIG. 1. In this state, the space of the first penetration portion 214 is increased by the force of the insertion of the connection member 11, and the first flexure 21 receives the first head 111 inward and may hold the first head 111 by pressing a rear half portion of the first head 111. The first head 111 may receive a pressing force acting from the left to the right in FIG. 1 by the support 24. As this pressing force and the pressing force of the first flexure 21 are balanced, the first head 111 may be maintained by being held in the certain space. The first head 111 and/or the rod 113 may perform a sliding motion on a contact surface between the first flexure 21 and the first head 111 and/or the rod 113. The first head 111 and/or the rod 113 may freely rotate on an axis (a rotational motion around the X-axis in FIG. 1). According to the above structure, when viewed from the first head 111 and constituent elements connected thereto, when received a force, the first head 111 and constituent elements connected thereto are capable of performing a linear translational motion in the X-axis and Z-axis directions and in a Y-axis direction (not shown) perpendicular to the X-axis and Z-axis directions, and capable of performing a rotational motion around each of the X-axis, the Y-axis, and the Z-axis. When the force is removed, the first head 111 and constituent elements connected thereto may be returned to the original position, or when the received force is changed, the first head 111 and constituent elements connected thereto may be moved to a new position in response to the changed force.

The connection member 11 may escape out of the first flexure 21 in the X-axis direction. In other words, when the connection member 11 is pulled out from the left to the right in FIG. 1 in the X-axis direction by applying a pressure over an elasticity generation threshold value of the first flexure 21, the first flexure 21 is bent outwardly and the first penetration portion 214 expands, and thus the first head 111 may be drawn out of the first flexure 21. In this state, the elasticity generation threshold value of the first flexure 21 is not limited to an elasticity threshold value of a material forming the first flexure 21, and may signify a value at which the first flexure 21 is bent by a pressure applied to the connection member 11 and thus the connection member 11 may move from one side to the other side by penetrating through the first flexure 21.

The connection member 11 may be combined to or separated from the first flexure 21 by the first flexure 21 that is an elastic body, and thus a smooth joint apparatus in which the first flexure 21 and the connection member 11 are capable of being combined to or separated from each other by a certain amount of force, not a joint apparatus in which the first flexure 21 and the connection member 11 are fixedly coupled to each other, may be implemented.

FIG. 2 illustrates a configuration of a first flexure 21′ according to another embodiment. In FIG. 2, the first flexure 21′ having a plate shape may be substantially in a “W” shape by changing a direction of a bending angle and/or a curvature angle three times in a zigzag form. Accordingly, the first flexure 21′ may include a first protruding portion 215 and a second protruding portion 216 protruding toward the inside of the first fixing unit 31. A recess portion 217 may be located between the first protruding portion 215 and the second protruding portion 216. The first flexure 21′ configured as above may be provided in plurality to extend from the first fixing unit 31 radially surrounding the first head 111 and supporting the first head 111 at a plurality of positions.

A penetration portion, through which the first head 111 passes, is formed by the first protruding portion 215 of the first flexure 21′, which is provided in plurality, and the second protruding portion 216 may prevent the first head 111 from advancing in the X-axis direction. The first protruding portion 215 and the second protruding portion 216 may not be formed to be sharp as illustrated in FIG. 2, and may have a gently curved shape. A protrusion length and a bending/curvature angle of the first protruding portion 215 may be identical to the protrusion length and the bending/curvature angle of the second protruding portion 216. However, the present disclosure is not limited thereto and the protrusion length and the bending/curvature angle of the first protruding portion 215 may be different from the protrusion length and the bending/curvature angle of the second protruding portion 216 according to a degree of design.

The recess portion 217 located between the first protruding portion 215 and the second protruding portion 216 may surround at least part of the first head 111 accommodated in the first flexure 21′. To this end, as illustrated in FIG. 2, the recess portion 217 may be curved roughly forming an arc. However, the present disclosure is not limited thereto, and a center or a part of the recess portion 217 may be bent.

The first flexure 21′ may have a first end portion 218 and a second end portion 219 at opposite ends thereof. The first end portion 218 may be a portion adjacent to the rod 113 that enters or exits, and the second end portion 219 may be an end portion opposite to the first end portion 218. According to an embodiment, the first end portion 218 may be coupled to the first fixing unit 31, and the second end portion 219 may be arranged spaced apart from the first fixing unit 31. Accordingly, the first flexure 21′ has elasticity in the Z-axis direction to allow the first head 111 passing through the penetration portion by the first protruding portion 215 to enter or exit. Although not illustrated in the drawings, according to another embodiment, the first end portion 218 may be arranged spaced apart from the first fixing unit 31, and the second end portion 219 may be coupled to the first fixing unit 31.

As illustrated in FIG. 2, in the first protruding portion 215, a surface facing the first end portion 218 may be gradually inclined compared to a surface facing the recess portion 217 to facilitate the insertion of the first head 111 inserted from the right to the left. Also, in the second protruding portion 216, a surface facing the recess portion 217 may be steeper than a surface facing the second end portion 219 to stop the first head 111 inserted from the right to the left in the recess portion 217. Accordingly, a force applied to the first head 111 when the first head 111 is pulled out of the recess portion 217 may be greater than a force applied to the first head 111 when the first head 111 is inserted into the recess portion 217.

In the first flexure 21′ configured as above, when the connection member 11 receives a force, the connection member 11 is capable of performing a linear translational motion in the X-axis, Z-axis, and Y-axis directions, and capable of performing a rotational motion around each of the X-, Y-, and Z-axes by the first flexure 21′. When the force is removed, the connection member 11 may be returned to the original position, or when the received force is changed, the connection member 11 may be moved to a new position in response to the changed force. Accordingly, the first flexure 21′ provides the six degrees of freedom to the connection member 11, thereby enabling linear and rotational motions in all direction in a space.

At least one first flexure 21′ may be provided in the first fixing unit 31 having a barrel shape. In an embodiment, four first flexures 21′, each having the first end portion 218 coupled to the first fixing unit 31, may be installed elastically supporting the first head 111 in a radial direction.

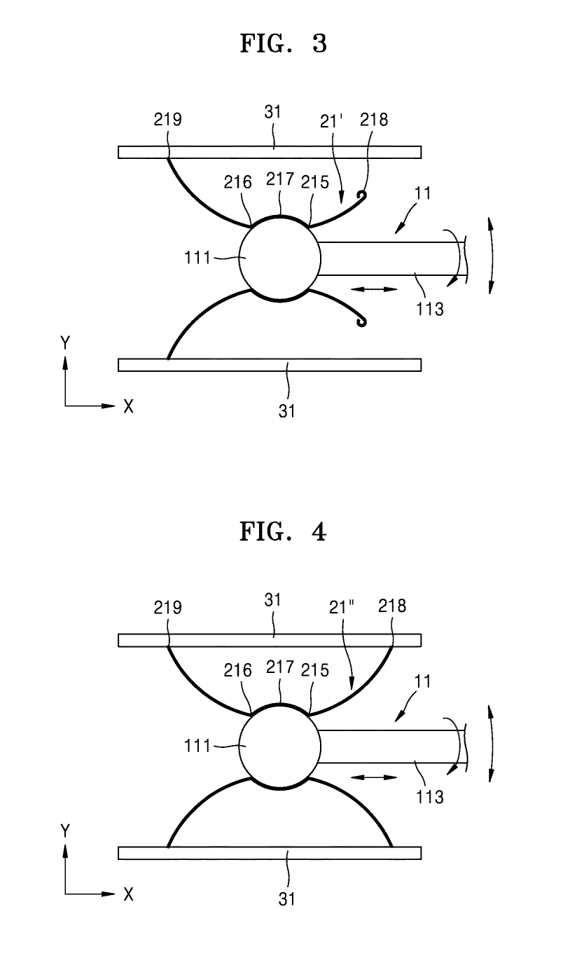

Alternatively, a pair of the first flexures 21′, as illustrated in FIG. 2, may be arranged with the first end portion 218 coupled to the first fixing unit 31 in the Z-axis direction, and as illustrated in FIG. 3, a pair of the first flexures 21′, as illustrated in FIG. 3, may be arranged with the first end portion 219 coupled to the first fixing unit 31 in the Y-axis direction perpendicular to the Z-axis direction.

Accordingly, the same effect may be obtained when the first head 111 is inserted from the right to the left in the X-axis direction or from the left to the right in the X-axis direction.

As illustrated in FIG. 4, in a first flexure 21″ according to another embodiment, both the first end portion 218 and the second end portion 219 may be coupled to the first fixing unit 31. In this case, a pressing force in the Z-axis direction may be greater than that described in the embodiment illustrated in FIGS. 2 and 3, and thus a relatively large force may be applied for the entering or exiting of the first head 111. In the present embodiment, the same effect may be obtained when the first head 111 is inserted from the right to the left in the X-axis direction or from the left to the right in the X-axis direction.

The first flexure 21′ (21″) having the above structure may not necessarily have a plate shape, and may have a bulk structure having a body. In other words, a first protruding portion and a second protruding portion may protrude from the body and a recess portion may be formed between the first protruding portion and the second protruding portion.

Furthermore, the first flexure 21′ (21″) may not necessarily include two protruding portions, and at least one protruding portion may suffice only if the protruding portion elastically supports the first head 111.

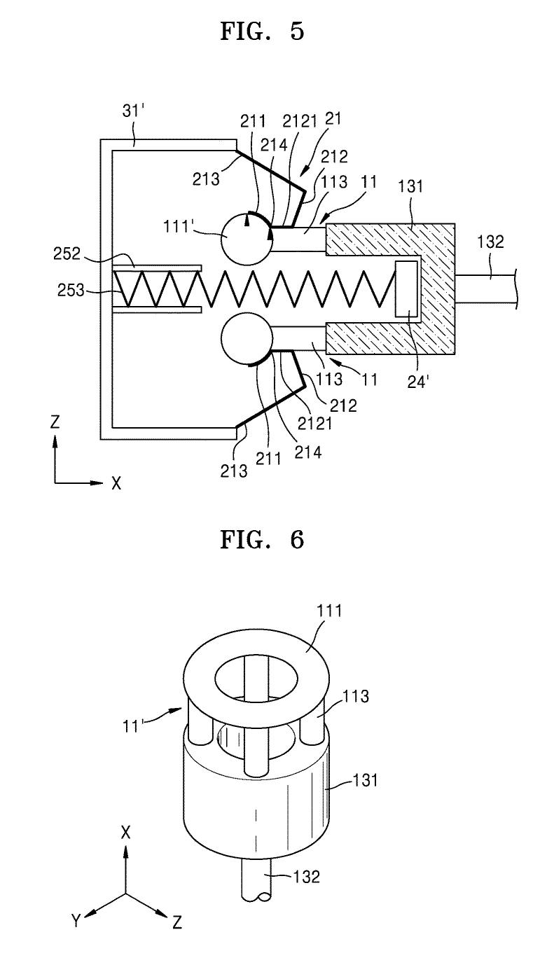

FIGS. 5 and 6 illustrate a configuration of a flexure joint apparatus according to another embodiment.

In the present embodiment, the connection member 11 may have a structure in which a plurality of rods 113 are connected to one first head 111 having a loop structure. However, the present disclosure is not limited thereto, and one rod 113 having a hollow pipe shape may be coupled to the first head 111. Alternatively, a plurality of rods 113 separated from one another may form a hollow pipe shape structure.

While in the embodiment illustrated in FIG. 6 the first head 111 has a donut ring structure having a circular plane surface, the present disclosure is not limited thereto and the first head 111 may have a hollow ring structure having a polygonal plane surface. In addition, the section of a ring is not limited to a circle and may be various shapes such as a polyhedral shape, an oval shape, a semicircular shape, a semi-elliptical shape, etc. Furthermore, the loop shape is not limited to a closed loop shape and may include a structure that is separated by at least one gap.

The rods 113 are connected by a first connection rod 131, and a second connection rod 132 is outwardly coupled to the first connection rod 131.

The first flexure 21 having the same shape as the first flexure 21 of FIG. 1 may be used, but the first flexure 21 in the present embodiment may have a structure in which, as illustrated in FIG. 5, a fourth extension portion 2121 is further provided between the first extension portion 211 and the second extension portion 212. However, the present disclosure is not limited thereto, and the first flexure 21′ (21″) that is any one of the embodiments illustrated in FIGS. 2 to 4 may be employed.

A first fixing unit 31′ may have a box shape, and a hole 252 is formed in the first fixing unit 31′ and a spring 253 is accommodated in the hole 252. An end portion of the spring 253 is connected to a support 24′, and the support 24′ supports the first connection rod 131. While, in the embodiment illustrated in FIG. 5, the support 24′ directly presses the first connection rod 131, the present disclosure is not limited thereto and, although not illustrated in the drawings, the support 24′ configured as an accommodation body surrounding part of the first head 111 may support the part of the first head 111. A force of the spring 253 pushing the connection member 11 in the X-axis direction from the left to the right in FIG. 5 may be stably maintained when the force of the spring 253 is balanced with a force of the first flexure 21 pushing the first head 111 in the X-axis direction from the right to the left.

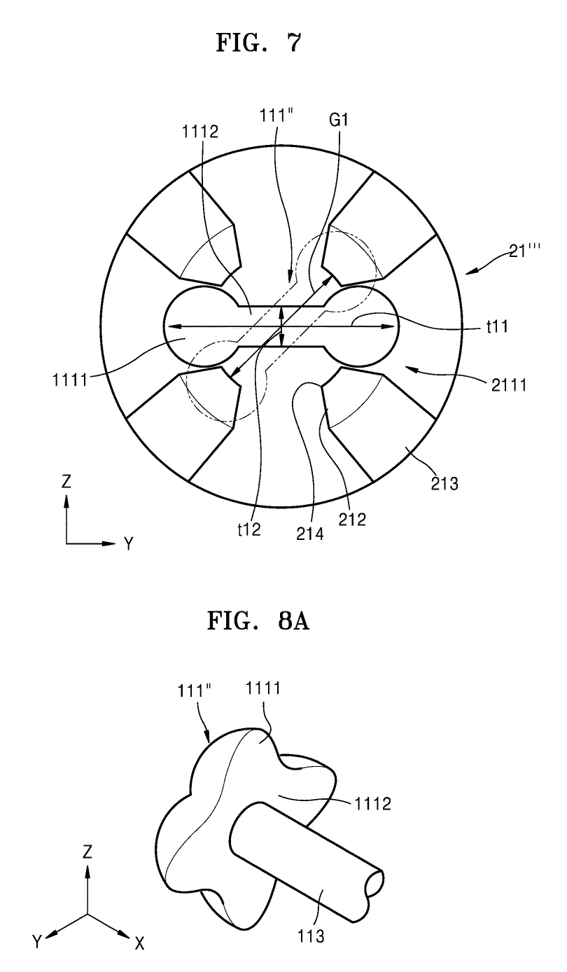

FIG. 7 is a plan view illustrated part of a flexure joint apparatus according to another embodiment.

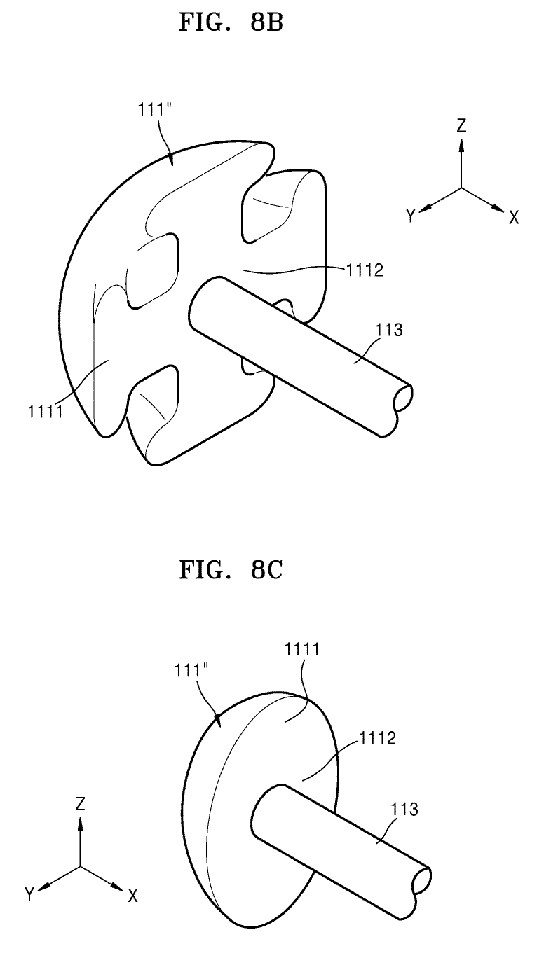

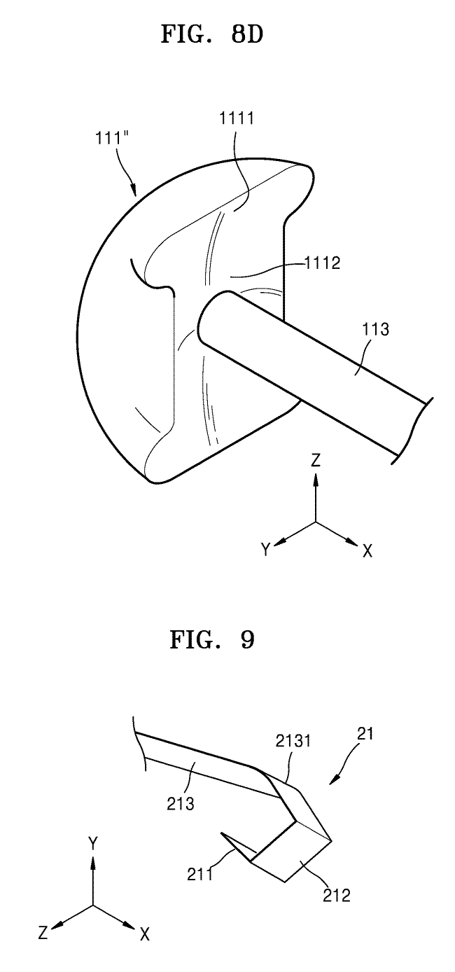

According to the embodiment illustrated in FIG. 7, a first head 111″ may include a first-1 portion 1111 having a first-1 thickness t11 in a Y-Z plane direction and a first-2 portion 1112 having a first-2 thickness t12 in the Y-Z plane direction that is less than the first-1 thickness t11. The first-2 portion 1112 may be a center portion connected to a rod, and the first-1 portion 1111 may be an edge of the first-2 portion 1112. The first-1 portion 1111 and the first-2 portion 1112 may extend in the Y-Z plane direction. The shape of the first head 111″ may correspond to the shape of FIG. 8D. Unlike the above, as illustrated in FIGS. 8A to 8C, in another embodiment, a center portion of the first head 111″ connected to the rod 113 has a relatively thicker thickness and an edge portion of the first head 111″ may have a relatively thinner thickness. A first flexure 21″′ may include a penetration portion 214 having a first size G1 that is less than the first-1 thickness t11 and greater than a first-2 thickness t12. A cracked portion 2111 may be formed between a plurality of first flexures 21″′. In the structure, the first head 111, as illustrated in FIG. 7, may pass through the penetration portion 214 and may be pressed beyond the first flexure 21″′. In this state, the first size G1 of the penetration portion 214 and a gap between the cracked portions 2111 increase, and thus, the first head 111″ may be inserted beyond the first flexure 21″′ by passing through the penetration portion 214. When the first head 111″ is rotated around the first-2 portion 1112 and the first-1 portion 1111 is located at a position overlapping the second extension portion 212, a movement of the first flexure 21″′ escaping from the first head 111″ in a reverse direction may be prevented, and thus the first head 111″ may be in a state of being unable to pass through the first flexure 21″′. Accordingly, according to the joint apparatus according to the present embodiment, the connection and disconnection of a joint may be regulated according to the rotation of the first head 111″. As described above, the first head 111″ may be provided by being inserted to pass through the first flexure 21″′ in a lengthwise direction of a rod and rotated along the plane formed by the Z-axis direction and the Y-axis direction. In this state, the first head 111″ is rotated by only a certain angle such that the first-1 portion 1111 may reciprocate between the cracked portion 2111 and the second extension portion 212, but the present disclosure is not limited thereto and the first head 111″ may continuously rotates.

Although the structure of the first flexure 21″′ is based on the first flexure 21 of FIG. 1, the present disclosure is not limited thereto and the first flexures 21′ and 21″ illustrated in FIGS. 2 to 4 may be employed.

FIGS. 8A to 8D illustrate various modified examples of a first head according to the embodiment illustrated in FIG. 7. As illustrated in FIGS. 8A and 8B, the first-1 portion 1111 may be provided in plurality radially in the Y-Z plane around the first-2 portion 1112. As illustrated in FIGS. 8C and 8D, the sectional shape of the first head 111″ is substantially oval.

The first head 111″ may be provided to be asymmetric in the axial direction of the connection member 11. In other words, as illustrated in FIGS. 8A to 8D, a portion of the first head 111″ connected to the rod 113 in the X-axis direction may be referred to as a rear portion and the opposite portion in the X-axis direction may be referred to as a front portion. In the first head 111″, the shapes of the front portion and the rear portion may be different from each other. For example, the front portion of the first head 111″ may have a curved surface and/or an inclined surface that is curved or at a gentle angle, to make it easier to pass through the penetration portion 214. In contrast, the rear portion of the first head 111″ may have a curved surface and/or an inclined surface of a sharper angle to restrict the passing of the first head 111″ through the first flexure 21″′ in a reverse direction. Accordingly, after the first head 111″ is inserted as the front portion of the first head 111″ passes through the penetration portion 214 and then the first flexure 21″′, a reverse-directional movement of the first head 111″ is restricted. Only when a specific axial rotation angle is reached, the first head 111″ may be drawn outward by passing through the penetration portion 214 by the reverse-directional movement.

Alternatively, when viewed in the X-axis direction, the section of the first head 111″ may be asymmetrically provided radially on the Y-Z plane. This is not applied only to the embodiments illustrated in FIGS. 7 to 8D, but applied to all heads described in the present specification. In other words, when a head has a shape that does not necessarily include symmetry with respect to a particular axis, it may function as a flexure joint apparatus. When the above asymmetric head is employed, the flexure that supports the head may be asymmetrically designed.

The embodiments according to FIGS. 7 and 8A to 8D may be widely applied to buttons including fastening snap buttons, hook buttons, etc. In other words, by initially pressing the first head 111″, the first head 111″ may pass through the penetration portion of the first flexure to be in a closed state, and then the first head 111″ is rotated on an axis in the pressing direction and drawn by pressing later in the reverse direction to the initial pressing direction, thereby releasing the closed state.

FIG. 9 illustrates another example of the first flexure 21 of FIG. 1. The first flexure 21 may further include a twisted portion 2131 that is twisted in an extension direction. By controlling a degree of twist of the twisted portion 2131, an installation position of the first flexure 21 with respect to the first fixing unit 31 and holding positions of the first head 111 by the first flexure 21 may be freely changed.

Although the embodiment of FIG. 9 illustrates that the twisted portion 2131 is formed on the third extension portion 213, the present disclosure is not limited thereto and the twisted portion 2131 may be located at at least part of the first extension portion 211 to the third extension portion 213. In addition, the twisted portion 2131 as described above may be applied to the first flexure 21 including the fourth extension portion 2121, as illustrated in FIG. 5, and to the first flexure 21″′ as illustrated in FIG. 7.

Furthermore, the twisted portion 2131 may be applied to the first flexure 21′ (21″) of FIGS. 2 to 4, between the first protruding portion 215 and the first end portion 218 and/or between the second protruding portion 216 and the second end portion 219. The twisted portion 2131 may be applied to the flexures of all embodiments in the present specification.

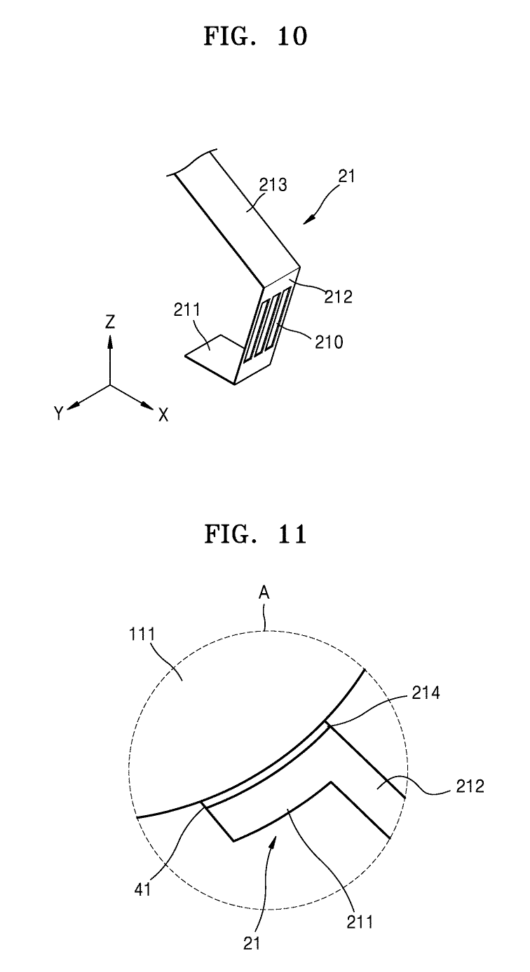

FIG. 10 illustrates another example of the first flexure 21 of FIG. 1. The first flexure 21 may further include at least one slit 210. The slit 210 may control a degree of bending and/or an elastic restoration force of the first flexure 21. In other words, the first flexure 21 including the slit 210 may be bent further and the elastic restoration force may become relatively weak. Accordingly, by adjusting the number, length, and shape of the slit 210, the elastic strength of the first flexure 21 may be controlled. Also, by changing the position of the slit 210 in a plurality of the first flexures 21, a degree of elastic support of the first head 111 by the first flexure 21 may be freely designed.

Although the embodiment of FIG. 10 illustrates that the slit 210 is formed in the second extension portion 212, the present disclosure is not limited thereto and the slit 210 may be located at at least part of the first extension portion 211 to the third extension portion 213. In addition, the slit 210 as described above may be applied to the first flexure 21 including the fourth extension portion 2121, as illustrated in FIG. 5, and to the first flexure 21′″ as illustrated in FIG. 7.

Furthermore, the slit 210 may be applied to the first flexure 21′ (21″) of FIGS. 2 to 4, between the first protruding portion 215 and the first end portion 218 and/or between the second protruding portion 216 and the second end portion 219, and/or at the recess portion 217. The twisted portion 2131 may be applied to the flexures of all embodiments in the present specification.

FIG. 11 illustrates another example of the flexure joint apparatus of FIG. 1, in detail, an example of a portion A of FIG. 1.

According to the embodiment illustrated in FIG. 11, an adhesive 41 may be further provided between the first extension portion 211 of the first flexure 21 and the first head 111. For example, the first flexure 21 and the first head 111 may be bonded to each other by the adhesive 41. Accordingly, the first flexure 21 and first the connection member 11 may be stably connected to each other.

According to another embodiment, the adhesive 41 may have elasticity. Accordingly, the first head 111 may be rotated within a certain range by being boned to the first extension portion 211. Furthermore, even when an impact is applied to the first head 111, the impact may be reduced by the adhesive 41, and thus damage to the flexure joint apparatus may be prevented.

The adhesive 41 as described above may be provided in a solid, a liquid, and/or a colloid state, but not limited to one capable of fixedly bonding the first flexure 21 and the first head 111. The adhesive 41 may bond the first flexure 21 and the first head 111 within a range of capable of mutually moving to a degree. For example, the adhesive 41 may be provided as a solid, a liquid, and/or a colloid having a certain degree of viscosity. Accordingly, the first flexure 21 and the first head 111 may be bonded to each other within a certain range only. Furthermore, a material such as grease providing lubricity between the first flexure 21 and the first head 111 may be employed only if it has a certain degree of viscosity to provide an adhesion within a certain range.

The adhesive 41 according to the above embodiments may be provided between the first flexures of all embodiment of the present specification and the first head. In addition, the adhesive 41 according to the above embodiments may be provided between the first head 111 and the support 24 in the embodiment of FIG. 1, or between a flexure having a different shape described later and a member elastically supported by the flexure.

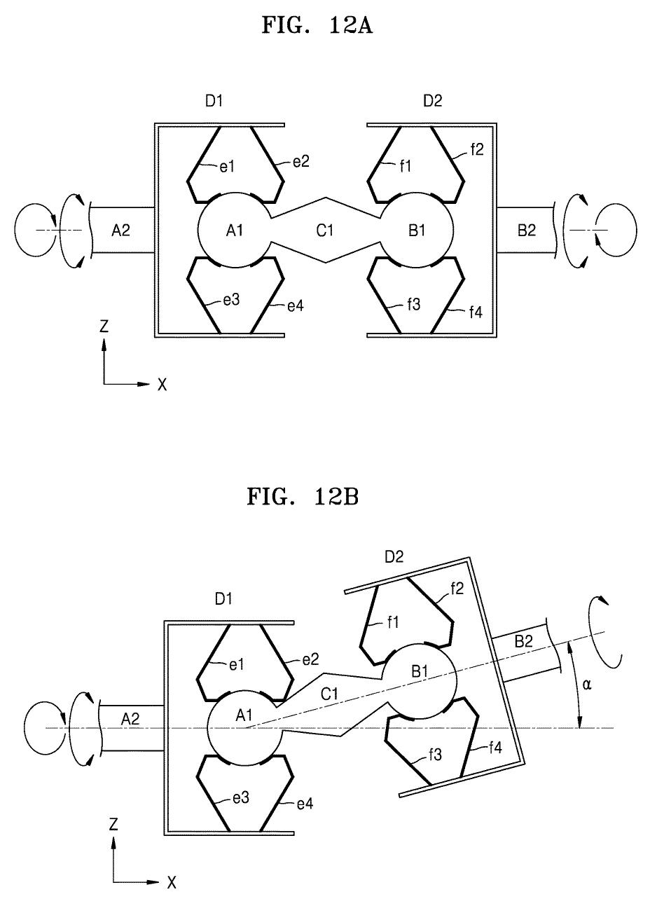

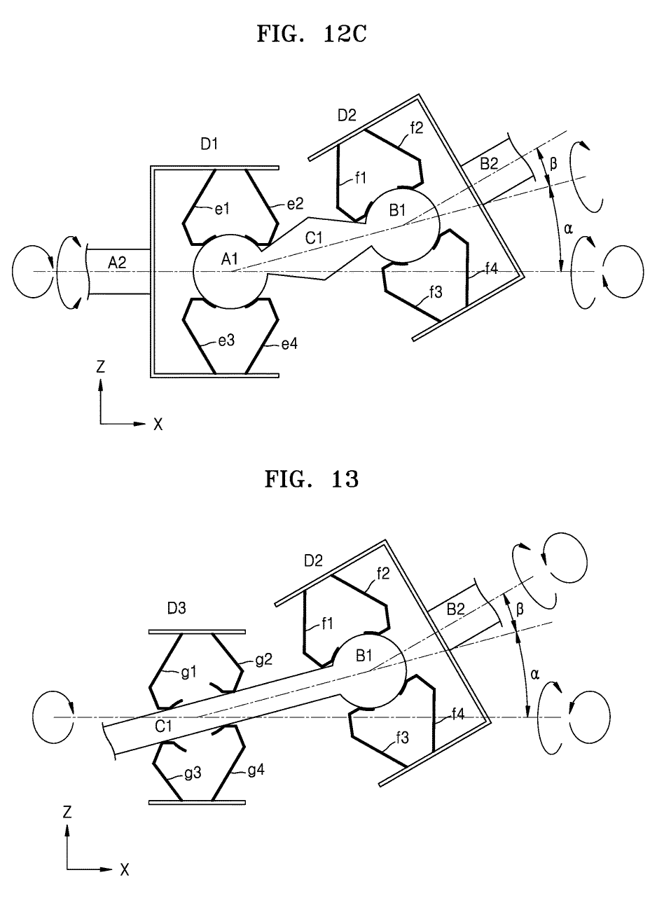

FIGS. 12A to 12C illustrate configurations of a flexure joint apparatus according to another embodiment.

Referring to FIGS. 12A to 12C, a first head A1 and a second head B1 are arranged facing each other, and the first head A1 and the second head B1 may be connected by a connection rod C1. A thickness of the connection rod C1 may vary in the X-axis direction. However, the present disclosure is not limited thereto and the thickness of the connection rod C1 may be constant in the X-axis direction. The first head A1 and the second head B1 may be located in a first fixing unit D1 and a second fixing unit D2, respectively.

First flexures e1 to e4 are installed in the first fixing unit D1, and second flexures f1 to f4 are installed in the second fixing unit D2. The first flexures e1 to e4 and the second flexures f1 to f4 may have the same structure as the first flexure 21 of FIG. 5, in which the third extension portion 213 is connected to the fixing unit 31′. However, the present disclosure is not limited thereto, and the first flexures e1 to e4 and the first flexures f1 to f4 may employ the flexure structures according to the above-described embodiments in the present specification.

A first outer rod A2 and a second outer rod B2 may be connected to outer surfaces of the first fixing unit D1 and the second fixing unit D2 facing each other. The first outer rod A2 and the second outer rod B2 each may be rotated around the X-axis or pivot by a certain angle. During the rotation of the first outer rod A2 and the second outer rod B2, a rotation force may not be transferred to the outer rod at the opposite side. When the first head A1 and the second head B1 is attached to the connection rod C1 via the adhesive, a rotation force of any one outer rod may be transferred to the other outer rod.

The first head A1 and/or the second head B1 each may escape from at least one of the first flexures e1 to e4 and the second flexures f1 to f4 of the first fixing unit D1 and/or the second fixing unit D2, by a linear motion in the X-axis direction, or may be inserted again.

As illustrated in FIG. 12B, due to the shape of the first head A1 and/or the elastic deformation of the first flexures e2 and e4, the second outer rod B2 may be raised up or lowered down by a first angle α from the X-axis. In this state, the first outer rod A2 and/or the second outer rod B2 may be rotated.

As illustrated in FIG. 12C, due to the shape of the second head B1 and/or the elastic deformation of the second flexures f1 and f3, the second outer rod B2 may be raised up or lowered down further by a second angle β in addition to the first angle α. In this state, the first outer rod A2 and/or the second outer rod B2 may be rotated.

As such, according to the present embodiment, the first outer rod A2 and the second outer rod B2 connected to each other by the joint apparatus may move in six degrees of freedom in a connected state as described above, and may be capable of being widened by a large angle in all directions such as up, down, left, and right.

FIG. 13 illustrates a flexure joint apparatus according to another embodiment. In the embodiment of FIG. 13, the rod C1 connected to the second head B1 is elastically supported by third flexures g1 to g4. The third flexures g1 to g4 are connected to a third fixing unit D3. The third flexures g1 to g4 may employ the flexure structure of all embodiments in the present specification. The second outer rod B2 is connected to the outer surface of the second fixing unit D2.

In the structure, due to the elastic deformation of the third flexures g1 to g4, the second outer rod B2 may be raised up or lowered down by the first angle a in the X-axis, and due to the shape of the second head B1 and/or the elastic deformation of the second flexures f1 and f3, the second outer rod B2 may pivot by being raised up or lowered down further by the second angle β in addition to the first angle α. In each state, the connection rod C1 and/or the second outer rod B2 may be rotated. In each state, the connection rod C1 and/or the second outer rod B2 may be rotated around the X-axis.

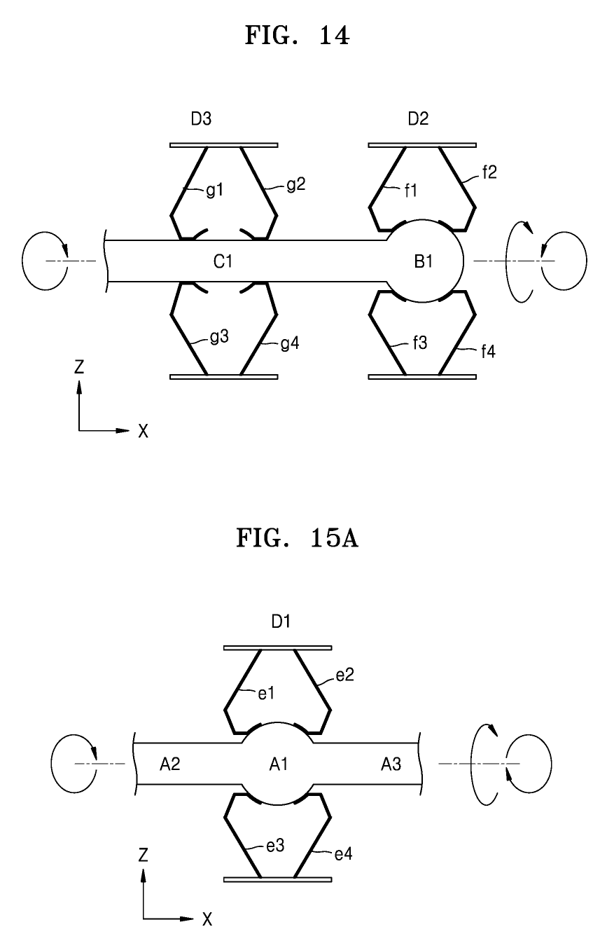

The embodiment of FIG. 14 is a modified example of the embodiment of FIG. 13, in which an external connection rode is not connected to the second fixing unit D2. In this state, the connection rod C1 may be rotated around the X-axis, and the third fixing unit D3 and/or the second fixing unit D2 may be rotated and X-axis. Also, the connection rod C1 may perform a linear motion in the Z-axis and Y-axis directions and a rotational motion in a fan shape forming an angle between the Z-axis and the Y-axis.

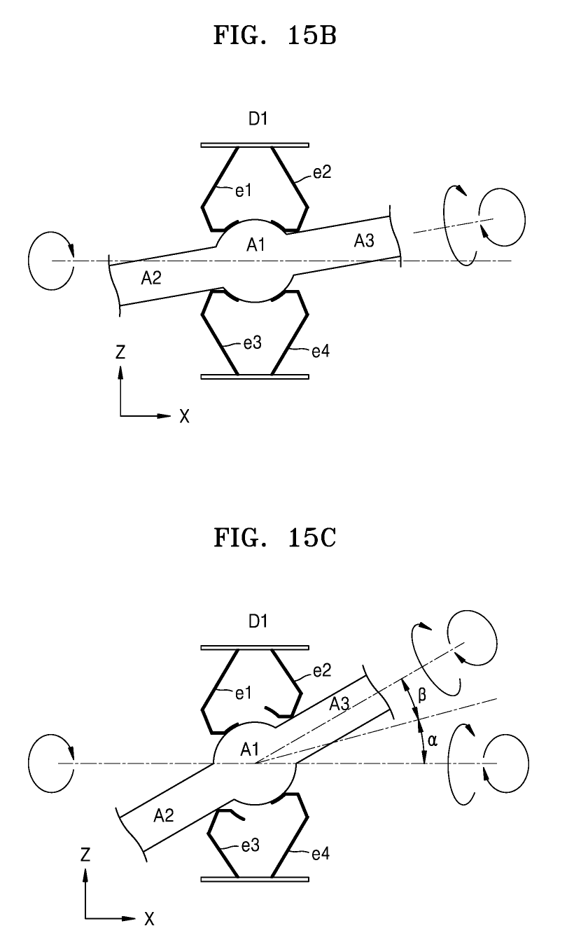

FIGS. 15A to 15C illustrate a part of a flexure joint apparatus according to another embodiment.

Referring to FIGS. 15A to 15C, the first head A1 is supported by the first flexures e1 to e4 in the first fixing unit D1, and the first outer rod A2 and a third outer rod A3 are connected to opposite sides of the first head A1.

In the structure, an assembly of the first outer rod A2, the first head A1, and the third outer rod A3 may be rotated, and as illustrated in FIG. 15B, due to the shape of the first head A1, the first outer rod A2 and the third outer rod A3 may pivot by the first angle α. As illustrated in FIG. 15C, due to the elastic deformation of the first flexures e1 to e4, in particular, e2 and e3, the first outer rod A2 and the third outer rod A3 may pivot by being raised up or lowered down by the second angle β in addition to the first angle α. In each pivot state, the assembly may be rotated around the X-axis.

As described above, the joint apparatuses according to the above-described embodiments may move in the six degrees of freedom, and may be capable of being widened by a large angle in all directions such as up, down, left, and right.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

### INDUSTRIAL APPLICABILITY

The flexure joint apparatuses according to the above-described embodiments are simple and capable of performing various joint functions of a human body, and thus the flexure joint apparatuses may be used in the fields of industrial robots or medial joint mechanism such as rehabilitation.

Furthermore, the flexure joint apparatuses according to the above-described embodiments may be used for all types of industrial products requiring a flexible support structure.

1. A flexure joint apparatus comprising:
a first fixing unit;
at least one first flexure extending from the first fixing unit; and
a connection member having a first head elastically supported by the at least one first flexure,
wherein the first head comprises a first-1 portion having a first-1 thickness and a first-2 portion having a first-2 thickness that is different from the first-1 thickness.

2. The flexure joint apparatus of claim 1, wherein the first flexure surrounds at least part of the first head.

3. The flexure joint apparatus of claim 2, wherein the first flexure comprises at least one recess portion, and the recess portion supports the first head.

4. The flexure joint apparatus of claim 2, wherein one end of the first flexure is coupled to the first fixing unit and the other end of the first flexure is spaced apart from the first fixing unit.

5. The flexure joint apparatus of claim 2, wherein the first flexure is provided such that opposite ends of the first flexure are coupled to the first fixing unit.

6. The flexure joint apparatus of claim 1, wherein the first head is provided asymmetrically with respect to an axial direction of the connection member.

7. The flexure joint apparatus of claim 1, wherein the first flexure further comprises a twisted portion that is twisted in an extension direction.

8. The flexure joint apparatus of claim 1, wherein the first flexure further comprises at least one slit.

9. The flexure joint apparatus of claim 1, further comprising an adhesive between the first flexure and the first head.

10. The flexure joint apparatus of claim 9, wherein the adhesive has elasticity.

11. A flexure joint apparatus comprising:
a first fixing unit;
at least one first flexure extending from the first fixing unit; and
a connection member having a first head elastically supported by the at least one first flexure,
wherein the first head is provided asymmetrically with respect to an axial direction of the connection member,
the first flexure surrounds at least part of the first head, and
the first head comprises a first-1 portion having a first-1 thickness and a first-2 portion having a first-2 thickness that is different from the first-1 thickness.

12. The flexure joint apparatus of claim 11, wherein the first flexure comprises at least one recess portion, and the recess portion supports the first head.

13. The flexure joint apparatus of claim 11, wherein one end of the first flexure is coupled to the first fixing unit and the other end of the first flexure is spaced apart from the first fixing unit.

14. The flexure joint apparatus of claim 11, wherein the first flexure is provided such that opposite ends of the first flexure are coupled to the first fixing unit.

15. The flexure joint apparatus of claim 11, wherein the first head is provided asymmetrically with respect to an axial direction of the connection member.

16. The flexure joint apparatus of claim 11, wherein the first flexure further comprises a twisted portion that is twisted in an extension direction.

17. The flexure joint apparatus of claim 11, wherein the first flexure further comprises at least one slit.

18. The flexure joint apparatus of claim 11, further comprising an adhesive between the first flexure and the first head.

19. The flexure joint apparatus of claim 18, wherein the adhesive has elasticity.

20. A flexure joint apparatus comprising:
a first fixing unit;
at least one first flexure extending from the first fixing unit; and
a connection member having a first head elastically supported by the at least one first flexure,
wherein the first flexure surrounds at least part of the first head and comprises at least one recess portion that is recessed close to the first fixing unit to support the first head,
the first flexure comprises a first protruding portion and a second protruding portion that protrude in a direction away from the first fixing unit and are spaced apart from each other,
the recess portion is located between the first protruding portion and the second protruding portion, and
the first protruding portion and the second protruding portion are spaced apart from each other from opposite ends of the first flexure.

21. The flexure joint apparatus of claim 20, wherein the first head comprises a first-1 portion having a first-1 thickness and a first-2 portion having a first-2 thickness that is different from the first-1 thickness.

22. The flexure joint apparatus of claim 20, wherein one end of the first flexure is coupled to the first fixing unit and the other end of the first flexure is spaced apart from the first fixing unit.

23. The flexure joint apparatus of claim 20, wherein the first flexure is provided such that opposite ends of the first flexure are coupled to the first fixing unit.

24. The flexure joint apparatus of claim 20, wherein the first head is provided asymmetrically with respect to an axial direction of the connection member.

25. The flexure joint apparatus of claim 20, wherein the first flexure further comprises a twisted portion that is twisted in an extension direction.

26. The flexure joint apparatus of claim 20, wherein the first flexure further comprises at least one slit.

27. The flexure joint apparatus of claim 20, further comprising an adhesive between the first flexure and the first head.

28. The flexure joint apparatus of claim 27, wherein the adhesive has elasticity.
